(19) United States
(12) Patent Application Publication
(10) Pub. No.: US 2018/0066960 A1
(43) Pub. Date: Mar. 8, 2018

(54) APPARATUS AND METHOD FOR DRIVING ASSISTANCE

(71) Applicant: DENSO CORPORATION, Kariya-city (JP)

(72) Inventors: Kojiro Tateishi, Kariya-city (JP); Naoki Kawasaki, Nishio-city (JP); Shunsuke Suzuki, Kariya-city (JP); Hiroshi Mizuno, Kariya-city (JP); Kenji Muto, Kariya-city (JP); Yusuke Tanaka, Kariya-city (JP); Masataka Konishi, Kariya-city (JP)

(21) Appl. No.: 15/697,174

(22) Filed: Sep. 6, 2017

(30) Foreign Application Priority Data
Sep. 7, 2016 (JP) 2016-175007

(51) Int. Cl. G01C 21/36; G01C 21/30; G05D 1/02; G05D 1/00

(52) U.S. Cl. CPC G01C 21/3697; G01C 21/30; G05D 2201/0213; G05D 1/0061; G01C 21/3676; G05D 1/0274

(57) ABSTRACT

A method and apparatus for driving assisting provided with an ECU which includes an extraction unit extracting a shape and a distribution of a landmark on a plurality of routes leading to a destination on a map, an accuracy calculation unit calculating an estimated accuracy of a vehicle position at each sampling point positioned at predetermined intervals on each route, on the basis of the shape and distribution of each landmark, an operating ratio calculation unit calculating an operating ratio of a driving assistance control on each of the routes, on the basis of the calculated accuracy at each sampling point, and a route selection unit which enables a driver of the vehicle to select a route among the plurality of routes, after the calculated operating ratio is presented to the driver.

### CROSS-REFERENCE RELATED APPLICATION

The application is based on and claims the benefit of the priority of earlier Japanese application No. 2016-175007, filed on Sep. 7, 2016, the description of which is incorporated herein by reference.

### BACKGROUND

### Technical Field

The present invention relates to techniques for assisting a driver, and more particularly relates to an apparatus and a method for assisting driving of a vehicle in which the apparatus is mounted based on a position of the vehicle.

### Related Art

Driver assistance systems and assistance functions which are used to assist the driver of the motor vehicle and to provide safe driving, are implemented in modern motor vehicles. Apparatuses that assist the driver, for example, those used for automatic driving control and lane-keeping assist or lane assist, are also known. Information of a vehicle travelling and information on features in a surrounding area are obtained by using the position of the vehicle which is specified on the map, and the obtained information is used for driving assistance control.

JP-2015-141560-A, discloses a navigation apparatus which switches from automatic driving control mode, which is currently in operation, to a manual driving mode, when the automatic driving control is interrupted, when it is necessary to temporarily discontinue automatic driving. In the disclosure, for example, in situations where information is acquired of a road feature showing a lane change, or weather information indicating a change in weather, the navigation apparatus determines that an interruption is required from the information obtained, and discontinues the automatic driving control. However, even when the event of the interruption of automatic driving control arises, the navigation apparatus may also determine it necessary to continue the automatic driving control mode, depending on the state of the driver, in which case the interruption of the automatic driving control is cancelled and reset to a later time.

However, the unexpected interruption of automatic driving control during driving assistance control can increase a workload of the driver. As described with the apparatus disclosed in the JP-2015-141560-A for example, in a case of resetting the time to discontinue automatic driving control, the driver must then prepare for the interruption of automatic driving control at the reset time. If the interruption of the driving assistance control occurs at an unexpected time, the driver may find it difficult to respond immediately, causing an increased burden on the driver. This situation applies especially when the motor vehicle is travelling on a road where interruption of vehicle assistance control occurs frequently, as the high frequency of interruption can be an increased burden.

In view of the foregoing, it is thus desired to provide an apparatus and method for driving assistance which is able to suppress interruption of vehicle assistance control at unexpected timings.

### SUMMARY

A driving assistance apparatus which performs driving assistance control of a vehicle, the driving assistance apparatus being operable to specify a position of a vehicle on the basis of a position on a map of a land mark provided along a road, and perform the driving assistance control on the basis of the specified position of the vehicle.

The apparatus is provided with an extraction unit which extracts either one of a shape and distribution of land marks on a plurality of routes to a destination on the map,

an accuracy calculation unit which calculates an estimated accuracy of the position of the vehicle being a position at a sampling point located at predetermined intervals along each of the routes, on the basis of the shape and distribution of the land marks,

an operating ratio calculating unit which calculates an operating ratio of the driving assistance control for each route, on the basis of the estimated accuracy of each calculated sampling point, and

a route selection unit which enables a driver to select one of the plurality of routes after the calculated operating ratio is presented to the driver.

In specifying the position of the vehicle on the basis of landmarks on the map, an accuracy of the position of the vehicle can be estimated for the vehicle travelling on each route, from the shape and distribution of the landmarks on the map. In this regard, the configuration is provided to extract either one of the shape and the distribution of the landmarks along the plurality of routes to the destination on the map, and calculate the estimated accuracy of the position of the vehicle at the sampling points located at predetermined intervals along each of the routes, on the basis of either one of the extracted shape and the distribution of the landmarks.

The operating ratio of the driving assistance control on each of the routes is calculated on the basis of the estimated accuracy of the sampling points, and the driver is enabled to select one of the routes from the plurality of routes after the calculation of the operating ratio is presented to the driver. The driver can thus select a route having a low interruption frequency of the driving assistance by referring to the operating ratio of the driving assistance control for each of the routes, and prevention of unexpected interruptions of the driving assistance control when the vehicle is travelling, may be actualized. The load on the driver is thus reduced.

### BRIEF DESCRIPTION OF DRAWINGS:

In the accompanying drawings;

FIG. 1A shows a configuration of a vehicle control apparatus;

FIG. 1B shows a functional block diagram of an ECU;

FIG. 2A shows features of nodes and links;

FIG. 2B shows registered curbs, division lines and road signs;

FIG. 2C shows registered shape information related with the division lines;

FIG. 3A schematically shows specification of a vehicle position using a measuring point of a landmark;

FIG. 3B shows a relative position of the landmark;

FIG. 4A descriptively shows extracted landmarks of a pull out part included in a sampling point;

FIG. 4B descriptively shows road signs included in a sampling point;

FIG. 5A descriptively shows sampling points taken from a present position to a destination;

FIG. 5B shows a selection screen of three candidate routes from a present position to a destination and calculated operating ratio for a first candidate route;

FIG. 6 is a flowchart showing a route selection process;

FIG. 7 is a flowchart describing a detailed process of a step shown in the flowchart of FIG. 6;

FIG. 8 descriptively shows extraction of landmarks and a low accuracy flag included in a searching range;

FIG. 9A schematically shows a first candidate route on a selection screen;

FIG. 9B schematically shows a second candidate route on the selection screen;

FIG. 10 is a flowchart of a method for calculating an error of the vehicle according to a second embodiment;

FIG. 11 shows an example of a calculated error of the vehicle;

FIG. 12 is a flowchart of a calculation method for recognized accuracy of a division line on each route according to a third embodiment; and

FIG. 13 schematically shows a recommended driving district of a third candidate route.

### EMBODIMENTS

Preferred embodiments for driving assistance apparatus and a method thereof according to the present disclosure will now be described with reference to the drawings. It is noted that the same symbols in the drawings are used to describe parts which are the same in each embodiments.

### First Embodiment

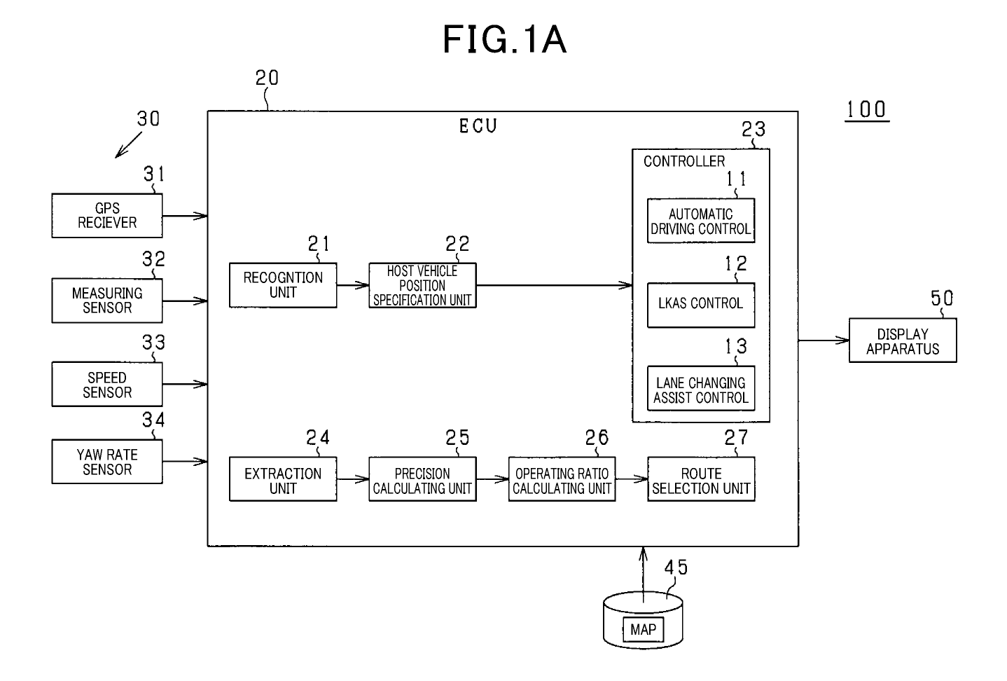

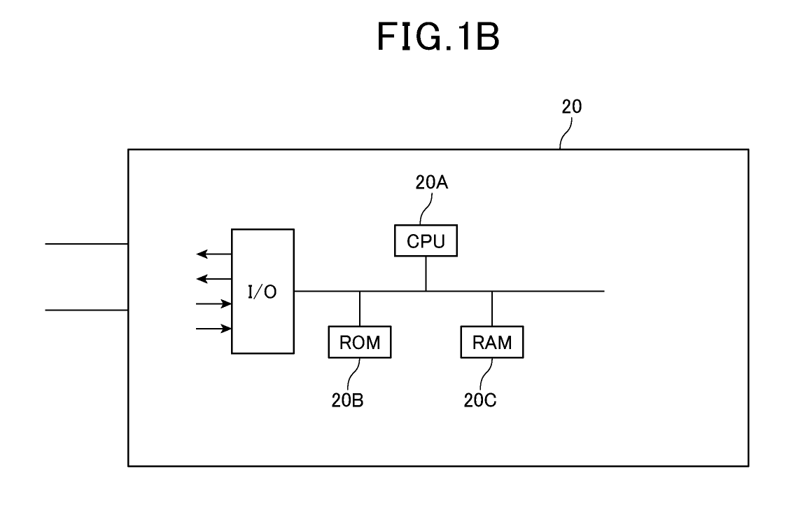

The driving assistance apparatus of the first embodiment is configured as a part of a vehicle control apparatus which controls a vehicle. The vehicle control apparatus supports running of a vehicle using the position of a vehicle calculated by the driving assistance apparatus. A configuration of a vehicle control apparatus 100 is described with reference to FIG. 1A. The vehicle control apparatus 100 is provided with various sensors 30, an Electronic Control Unit EC 20 which functions as the driving assistance apparatus, and a display 50.

The sensors 30 include a Global Positioning System (GPS) receiver 31, a measuring sensor 32, a vehicle speed sensor 33 and a yaw rate sensor 34.

The GPS receiver 31 functions as a known Global Navigation Satellite System (GLANS), so that radio waves transmitted from satellites (globally) are received as GPS information. The GPS information includes a global position and a transmitted time of the radio waves. The GPS receiver 31 calculates a distance from the satellite to the vehicle CS, based on a difference between a received time of the GPS information and transmitted time included in the GPS information. The calculated distance and global position are then output to the ECU 20.

The measuring sensor 32 measures a relative position which is a reference position of the vehicle from an object in front of the vehicle. An image sensor such as a stereo camera or a laser radar, for example, may be used as the measuring sensor 32. In the case of using the stereo camera, a distance image having a three dimensional distance included is generated using a stereo image captured in front of the vehicle, and feature points of road side objects included in the distance image are sequentially calculated as measuring points. A single lens camera may also be used as the measuring sensor 32.

The speed sensor 33 is provided on a rotation shaft which transmits power to the wheels of the vehicle. A speed of the vehicle is detected on the basis of a rotation number of the rotation shaft. The yaw rate sensor 34 detects a yaw rate generated at the vehicle i.e. an angular speed around a central point of the vehicle.

As shown in FIG. 1B, the ECU 20 is a computer system provided with a CPU (Central Processing Unit) 20A, a ROM (Read Only Memory) 20B, and a RAM (Random Access Memory) 20C. More specifically, the ECU 20 is provided with the CPU 20A performing a main control process, the ROM 20B which stores predetermined programs and functioning as a non-transitory storage media, and the RAM 20C. The CPU 20A functionally actualizes each control unit described hereinafter, by executing each program stored in the ROM 20B. The RAM 20C functions as a memory temporarily storing data of which a process thereof is executed by the CPU 20A.

The ECU 20 is connected to an external memory 45 and may be operable to acquire the shape and a position of a road on which the vehicle is travelling by reference to a map stored in the external memory 45.

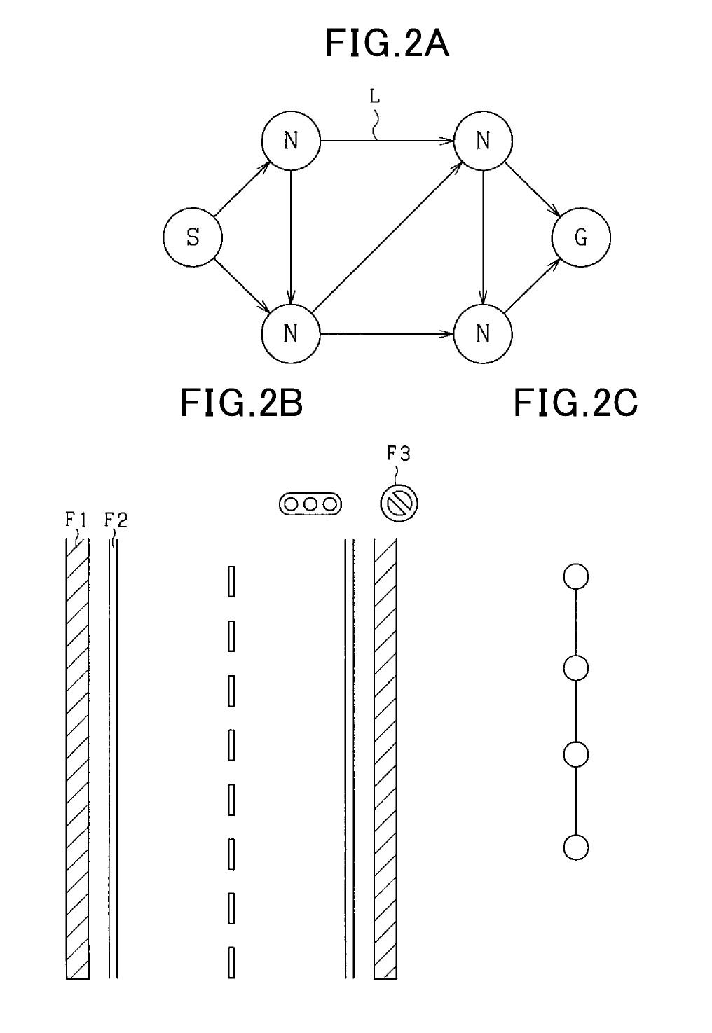

A link indicating a road lane on a road and a node indicating a connection point of the road lane are registered on the map. An absolute co-ordinate on the map is recorded in the node, thus, a corresponding position to the node is detectable. The ECU 20 can calculate the route from a specific position to a destination by using a connecting relation between the nodes and links. As shown in FIG. 2A, calculation of a plurality of routes joining a starting point S and destination may be actualized by combining the plurality of nodes N which connect nodes from the specific starting point S to the destination with G links L.

The shape and the attribute information of a predetermined landmark existing on the map is linked to the specific position thereof and recorded. The landmark is thus a feature recorded based on attribute information and the shape thereof. The landmarks mentioned here include, for example, road side objects existing on a road shoulder, or a division line which divides a boundary on a road also referred to road boundary, road signs, traffic lights and signs on road surfaces. The attribute information is information showing a landmark name or related information, for example. The ECU 20 searches for a landmark on the map by using the attribute information and is operable to acquire the searched landmark position and acquire the shape information.

FIG. 2B shows each landmark of curbs F1, division lines F2 and road signs F3 which are registered on the map. FIG. 2C shows registered shape information, which corresponds to the division line F2 shown in FIG. 2B. The shape information is composed of representative points of landmark co-ordinates, and known vector data having an approximated curve which joins each of the representing points.

A low accuracy flag (low accuracy information) indicating when the measured accuracy of a landmark that is lower than a predetermined value is also registered on the map. More specifically, the low accuracy flags are information indicating a low accuracy which was measured for the landmark at the time at which the map was constructed. For example, a low accuracy flag is registered to a relative position of a landmark, and is searchable using attribute information.

The display apparatus 50 shown in FIG. 1A for example, is a vehicle instrument panel provided inside the vehicle, which can be visually recognized by the driver. The display apparatus 50 is equipped with a display showing an image configured of an LCD panel, and an operation unit which functions as a user-interface, for example, which displays a map of surroundings of a present position of the vehicle. The operation unit is operated by the driver and a resultant data can be input into the ECU 20 through the display apparatus 50. The operation unit may also be an operation key configured to perform operations separately from the display, or a touch panel operable by registering an operation using icons provided on a screen.

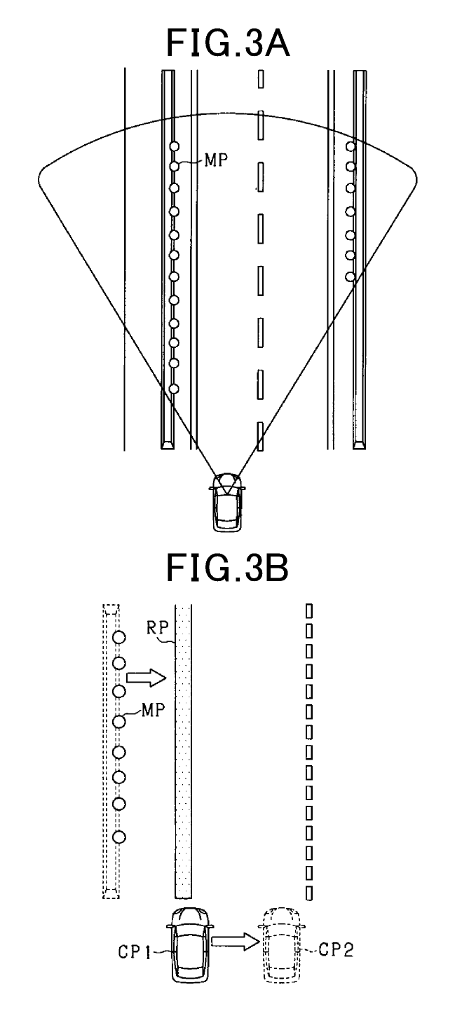

A recognition unit 21 recognizes landmarks in front of the vehicle, on the basis of a result measured by the measuring sensor 32 which is mounted on the vehicle. The position of the measured point MP of a landmark, measured in front of the vehicle by the measuring sensor 32, is shown in FIG. 3A. The recognition unit 21 extracts the measuring points included in scanline data, and produces segments, which are groups of measuring points for every landmark by grouping the measured point into groups. The segments are produced by using a distance between the measured points and by grouping the measured points corresponding to a position thereof.

The vehicle specification unit 22 specifies the position on the map of the vehicle, based on the positions of the landmarks. The specification of the position of the vehicle is corrected on the basis of a position alignment results in which case the vehicle position on the map is aligned using the landmark position on the map and a recognized landmark position recognized at the recognition unit 21. In this manner, each of the above mentioned positions are obtained based on measured results from the GPS receiver 31, vehicle speed sensor 33 and the yaw rate sensor 34. The GPS receiver 31, vehicle speed sensor 33 and the yaw rate sensor 34 thus function as position measuring sensors.

As shown in FIG. 3B, the position of the vehicle is recognized by the position alignment of the relative position of the landmark MP recognized at the recognition unit 21, with the landmark position RP indicated shape information on the map. Specifically, each of the measuring points MP, which are positions of relative co-ordinates as a reference for the vehicle position, are converted to positions in absolute coordinates, based on an estimated position CP1 of the vehicle on the map. As a result, by the position alignment of the converted measured points MP and the landmark position RP, a deviation amount between the two positions is calculated.

For example, in using a determinant which employs elements of the deviation between the position of the measuring point MP after conversion and the position RP on the map, both positions are aligned and the deviation between both positions may be calculated by solving each element of the determinant. In correcting the position CP1 on the map by using the calculated deviation, the position of the vehicle is specified on the map by using the vehicle position after correction CP2.

The controller 23 controls the driving assistance control of the vehicle based on the vehicle position specified on the map. In the first embodiment, the controller 23 is provided with each function of a vehicle driving control unit 11, a lane keep assist control unit (LKAS control section) 12, and a lane change assist control unit 13. The function of these units may be selected by operation of an operation button disposed at the driver seat. The controller 23 controls the drive assist control of the vehicle on the basis of recognition results of the division lines which are recognized using the recognition unit 21.

The automatic driving control unit 11 recognizes a present position on a lane based on the specified position of the vehicle and recognized division lines, and operates so that the vehicle travels along the lanes by control of a steering wheel device and an engine neither of which are not shown in the figures. The LKAS control section 12 predicts a future position of the vehicle using the position of the vehicle on the map, the vehicle speed and the yaw rate, and determines a probability of the vehicle departing from an own lane, designated by the boarder lines. At this point, if it is determined that the vehicle may depart from the own lane, an alert is shown on the display apparatus 50 to inform the driver. The lane changing assist control unit 13 changes from the present own lane to an adjacent lane designated by the division line, when the driver operates a direction indicator by control of the steering apparatus.

However, according the controller 23 controlling the driving assistance control, the driving assistance control presently operating may be disrupted in areas having a low accuracy of the vehicle position on the map. More specifically, when the driving assistance control is unexpectedly interrupted at a particular point in time, it may be difficult for the driver to immediately respond, which may result in an increased load. This may apply especially when the vehicle is driving on a route where the driving assistance control is frequently disrupted, and the load to the driver may be increased further as a consequence. It is to be understood that the “driver's load” or “increased burden” refers to various situations in which a sudden change from automatic to manual control causes an inconvenience to the driver. For example, when the vehicle is driving in areas with little road sign navigation and in a situations of sudden weather changes. As another example, it may also refer to a time of day, or a state of the driver, in which case the driver is relying on automatic drive control to reach a destination. The ECU 20 is operable to estimate a position of which the accuracy of the vehicle decreases for each route.

Now returning to FIG. 1A, the extraction unit 24 extracts the shape and distribution of the landmarks on the map which appear on the plurality of routes to the destination. For example, the landmarks may be continuously provided along a road, in which the extracting section 24 extracts the landmarks, which indicate a change in shape of the road. The change in the shape of the road is a lane diversion, a merging lane and a shape changed due to a pullout area formed on a road shoulder, for example. The extraction unit 24 extracts the shape of landmarks from division lines, curbs, road walls and road studs registered in the map, for example. Other than the above mentioned, the extracting section 24 may be operable to estimate the shape from nodes and links on the map. The extraction unit 24 also extracts the distribution of the landmark provided along the road. The extraction unit extracts the distribution of signs on a road and traffic lights, for example.

The accuracy calculation unit 25 calculates an estimated accuracy of the vehicle position at sampling points located at predetermined intervals on each of the routes, based on the shape and distribution of the landmarks extracted by the extraction unit 24.

The estimated accuracy is a value estimating the accuracy of the vehicle position specified by using a vehicle position specification unit 22, in the surrounding area, also referred to as a vicinity, of the sampling points. It is to be understood that the accuracy of the specified vehicle position in the vicinity of the sampling points may increase with a higher estimated accuracy. The sampling points are positions in which the estimated accuracy is calculated, dispersed along the route at intervals. The intervals of the sampling points on the map are set in a range between 10 meters or more to less than 100 meters on the map, for example.

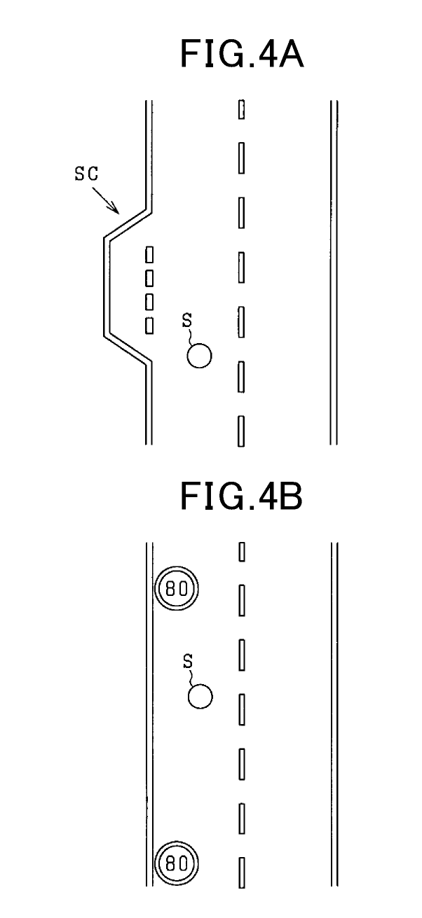

As shown in FIG. 4A if the pull out area, shown by a part of the division line which has a shape change section SC, appears in the vicinity of a sampling point the accuracy calculation unit 25 calculates a high estimated accuracy value, and if no shape change section SC exists in the vicinity of the sampling point, calculates as a low estimated value for this particular sampling point. More specifically, the shape change section is among road surface signs showing a boundary line of a road, which is partially oblique by a predetermined angle, in a direction along the road lane. In this manner, using such shape change section in the vicinity of the sampling points, the vehicle may be specified with high accuracy.

As a further example, when a plurality of road signs exist as a landmark in the direction of the road within the vicinity of the sampling point S, as shown in 4B the accuracy calculation unit 25 calculates the estimated accuracy as a high value, and when there no plurality of road signs which exist, the accuracy calculation unit 25 calculates the estimated accuracy as a low value. Moreover, if there is a high frequency of road signs and traffic lights, for example, provided along the road, the number of times of specifying the vehicle position may also be increased by using these landmarks.

The operating ratio calculating unit 26 calculates the operating ratio of the driving assistance control on each of the routes, on the basis of the estimated accuracy calculated at each of the sampling points. The operating ratio shows a predicted value of a frequency in which the driving assistance control is performed when the vehicle is travels on each route. For example, the estimated accuracy is a value from 0 per cent to 100 per cent, which is calculated on the basis of sampling points having an estimated accuracy that is higher than a threshold Th1.

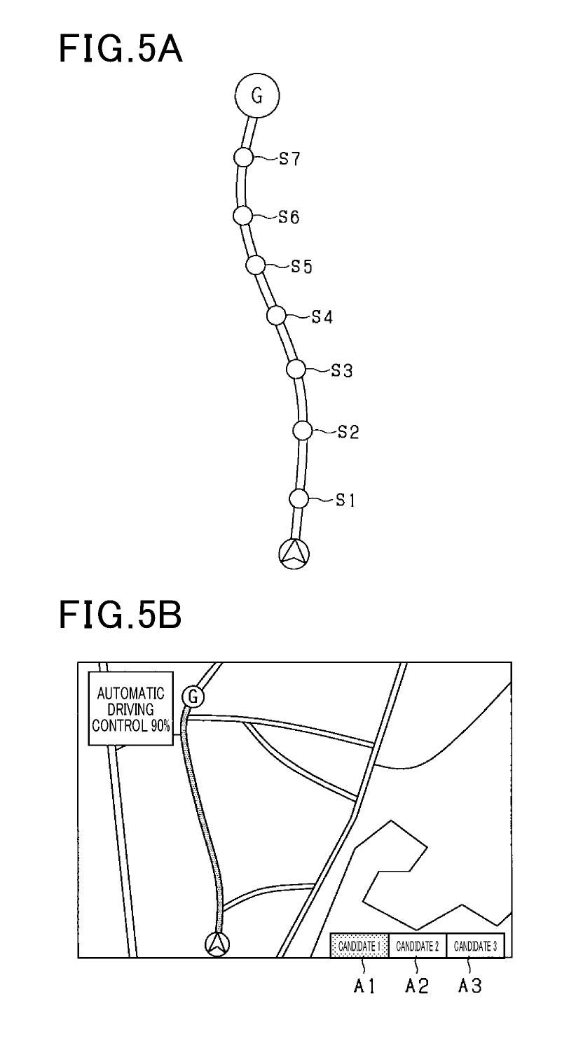

In FIG. 5A, 7 sampling points S1 to S7 are dispersed from a present existing point of the vehicle to a destination on the route shown. In this shown, when the estimated accuracy of the entire sampling points S1 to S7 is calculated to be higher than the threshold Th1 the operational per cent is 100%. In contrast, if the estimated accuracy of the sampling points S1 to S7 is calculated to be lower than the threshold Th1, the operating ratio is 0% per cent.

It is noted that, the threshold Th1 is a value which is set corresponding to an accuracy of the vehicle position, in which the driving assistance control is operable without interferences. In the event of each driving assistance control being interrupted at a different accuracy of the vehicle position, the threshold value Th1 may be changed for each driving assistance control.

The route selection unit 27 enables the driver to select one route among the plurality of routes, after the calculated operating ratio is presented to the driver. In FIG. 5B, a selection screen is shown by the route selection unit 27 on the display apparatus 50. The selection screen is equipped with switching icons A1 to A3 which each display one of three routes joining the present position and the destination. The operating ratio of the driving assistance control corresponding to the route displayed is also shown on the upper left part of the map of the selection screen. Specifically, the operation ratio corresponding to the route shown is displayed, and the route on the display is switched by operation of each icon.

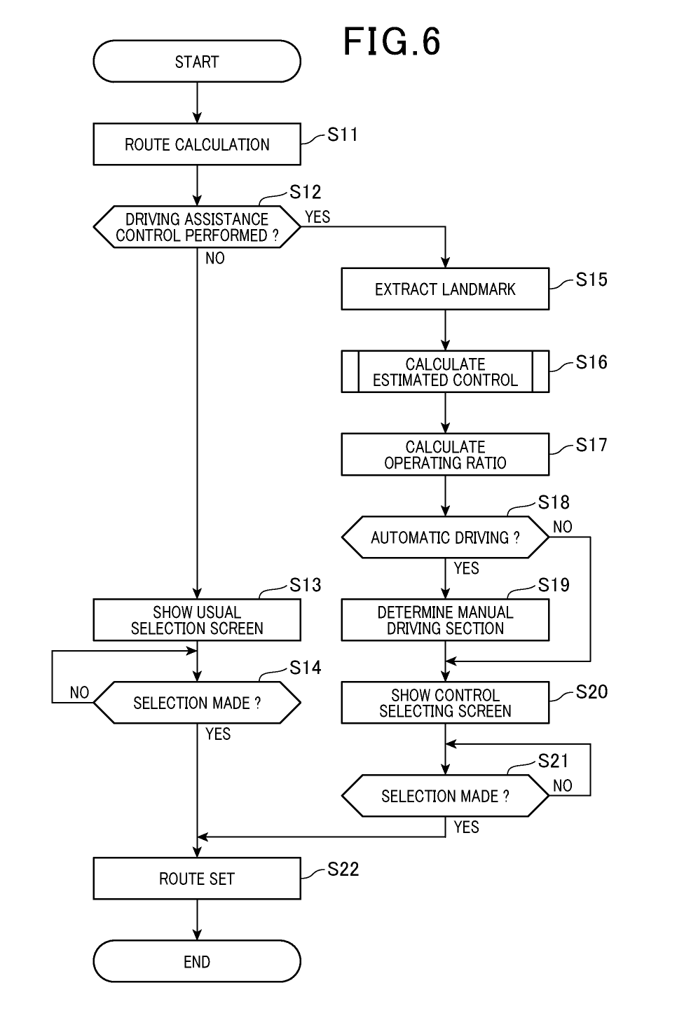

Next, route selection executed by the ECU 20 is described with reference to the flow chart shown in FIG. 6. It is to be understood that the ECU 20 performs steps of the flow chart shown in FIG. 6 at predetermined cycles.

Firstly, at step 11, a route is calculated from the present position of the vehicle to the destination. The ECU 20 calculates the plurality of routes according to a combination of nodes and links joining the destination with the present position of the vehicle, which is set by operation of the apparatus 50.

At step 12, it is determined whether operation of the driving assistance control has been selected. If the driving assistance control is not selected by the driver (NO at step S12), at step S13, a screen (i.e. a usual selection screen) showing each of the routes calculated at step 11 is displayed on the on the display apparatus 50, enabling the driver to select one of the routes. It is to be understood that the usual selection screen displays each of the calculated routes calculated at step S11, however at this point the operating ratio of the driving assistance control is not presented to the driver.

The driver then selects one of the routes presented on the usual selection screen by operation thereof (YES at step S14), and the route selected at step S22 is set as the travelling route of the vehicle. In this case, since operation of the driving assistance control has not been selected, the display apparatus 50 shows the vehicle to the destination according to the driving direction of the vehicle.

In contrast, when operation of driving assistance control is selected (YES at step S12) at step S15, the shape and distribution of the landmarks are extracted on each of the routes leading to the destination point on the map. The ECU 20 acquires a position of the division lines and distribution of the signs, for example, along each of the routes calculated at step S11. In this case, the step S15 functions as an extraction process.

At step S16, the estimated accuracy of the vehicle position is calculated on the basis of the shape and distribution of the extracted landmarks. For example, the sampling points which have the estimated accuracy calculated at step S16 are the entire sampling points calculated at step S11 on the routes. The step S16 is the accuracy calculation process.

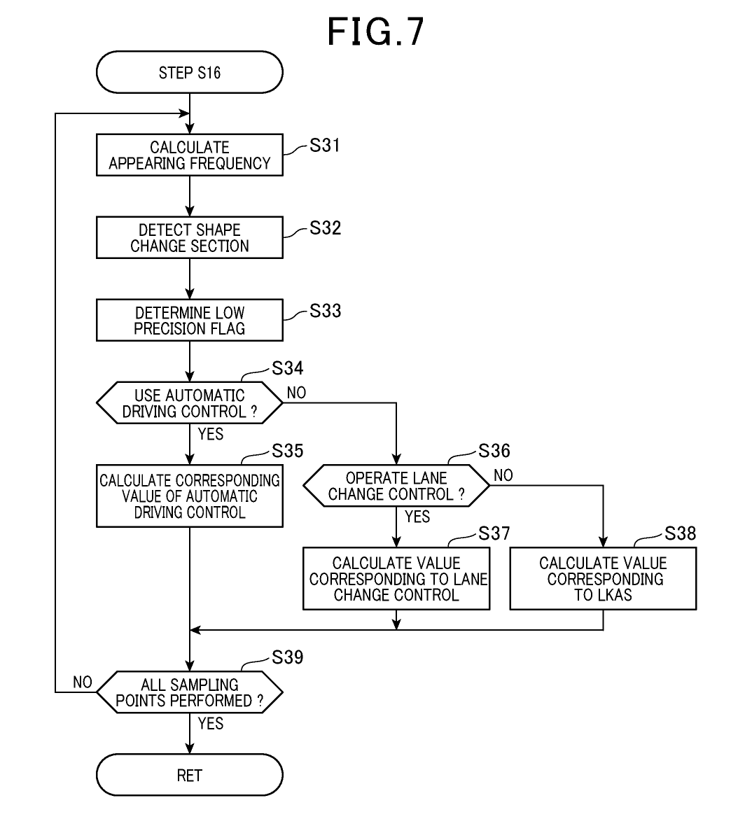

A detailed description of the process performed at step S16 in the flow chart shown in FIG. 6, is next described with reference to the flowchart shown in FIG. 7. Firstly, at step S31, calculation of an appearance frequency of the landmarks in the direction along the road in the vicinity of the sampling points is performed from the distribution of the landmarks on the map extracted at step S15.

The ECU 20 sets a search range, extending only to a predetermined distance in the direction of the road, as a reference sampling point. Specifically, the appearing frequency is calculated by using the distribution of signs and a number of traffic lights, within the searching range.

At step S32, it is determined whether a division line which has a shape change section exists on the road in the vicinity of the sampling points, among the landmark shapes extracted at step S15. For example, the ECU 20 determines whether a division line having a shape change section exists within the searching range set at step S31.

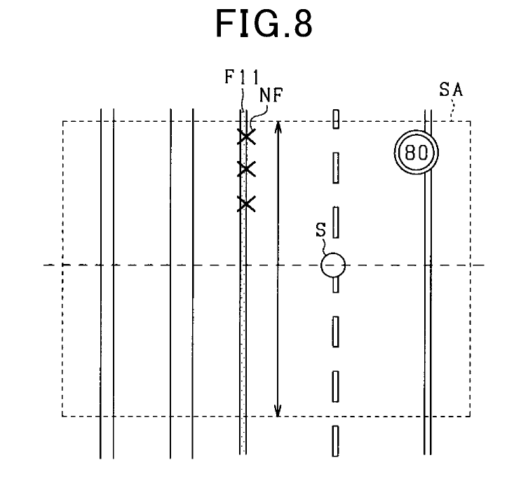

At step S33, it is determined whether a landmark having a registered low accuracy flag exists in the vicinity of the sapling points along the route on the map. For example, the ECU 20 determines whether a low accuracy flag is registered in the landmarks used in the process steps S31 and S32. In FIG. 8, the low accuracy flag NF is registered to a division line F11 within the searching range SA, on the map. In this case, the ECU 20 determines that a landmark having a low measuring accuracy exists in the vicinity of the sampling points.

Now returning back to FIG. 7, if the driving assistance control presently selected is the automatic driving control, (YES at step S34), at step S35 the estimated accuracy corresponding to the automatic driving control is calculated. It is to be understood that a high accuracy of the vehicle position on the map in both a length direction and a width direction of the road is preferable, for the operation of the automatic driving control. In this regard, if a division line having a shape change section does not exist in the vicinity of the sampling points, the estimated accuracy is calculated as a lower value, compared to when a shape change section does exist in the same vicinity. For example, an estimated accuracy EV1 is calculated using an equation (1) below.

EV1=K1·α (1)

In the equation (1), K1 is a variable provided when the automatic driving control is in operation and the value of K1 is set at a low value if a division line having a shape change section does not exist in the vicinity of the sampling points. A coefficient number α is added, as shown in the equation (1) when a low accuracy flag is registered on a landmark. For example, the coefficient number α is less than 1 and is equal to or greater than 0. From the above equation (1), the estimated accuracy is calculated as a lower value when a low accuracy flag is registered at a landmark, compared to when a low accuracy flag is not registered.

If the driving assistance control is not the automatic driving control (NO at step 34), and a lane change control is operated (YES at step S36), an estimated accuracy is calculated which corresponds to the lane change control at step S37. A high accuracy of the direction along the road on the map is also preferable, during the lane change control. In the case of selecting the lane change control, the estimated accuracy is calculated as a high value if a division line having a shape change section is positioned in the vicinity of the sampling points, or the appearance frequency of the landmarks is high. For example, the ECU 20 calculates an estimated accuracy EV2 by using an equation (2) shown below.

EV2=K2·β (2)

In the equation (2), a variable K2 is a low value when either a division line having a shape change section does not existing in the vicinity of the sampling points, or the appearing frequency of the landmarks is low. A coefficient number β is added when a low accuracy flag is registered to the landmarks used to calculate the estimated accuracy. The coefficient number β is equal to or greater than 0 and less than 1.

In contrast at step S36, when the lane change control is not selected by the driving assistance control (NO at step S36), the estimated accuracy is calculated according to LKAS control. It is to be understood that a high accuracy of the vehicle position on the map is preferable, in both the length direction and width direction of the road for the LKAS control. In this regard, the estimated accuracy is calculated as a low value if there are no landmarks existing within the range of the sampling points. For example, the ECU 20 calculates an estimated accuracy EV3 using an equation (3) shown below.

EV3=K3·γ (3)

The variable number K3 shown in the equation (3) is a low value when there are no division lines having a shape change section existing in the vicinity of the sampling points. The coefficient number γ is added to the equation 3 when a low accuracy flag is registered to a division line used to calculate the estimated accuracy. For example, the coefficient number γ is value that is equal to or greater than 0 and less than 1.

The variable corresponding to each of the driving assistance control described above, is a value, for example, set by a map which is not shown. As a result, the ECU 20 is operable to calculate the estimated accuracy as a input value of the shape or the appearing frequency of landmarks acquired at steps S31 and S32.

At step S39, if calculation of the estimated accuracy of all the sampling points for each of the routes calculated at step S11 has not been performed (NO at step S39), the process returns to step S31 and each of the process from steps S31 to S38 is performed for the remaining samples on the route. In contrast, if the estimated accuracy has been calculated for all of the samples on each of the routes at the previous process step S11 (YES at step S39), the process shown in the flowchart of FIG. 7 is completed, and the process proceeds to step S17 in the flowchart shown in FIG. 6.

In step S17, the operating ratio of the driving assistance control for each route is calculated on the basis of the estimated accuracy of each sampling point calculated at step S16. The ECU 20 calculates the operating ratio according to the number of sampling points which have a higher estimated accuracy than the threshold value Th1, for each route. The process step S17 is an operating ratio calculation process.

Next, if the automatic driving control is not selected (NO at step S18) the process proceeds to step S20. In contrast, if the automatic driving control is selected (YES at step S18), at step S19 it is determined whether there is a high possibility of manual driving being necessary for the vehicle on unit sections of the route. The necessity of manual driving is determined on the basis of the number of sampling points having a low estimated accuracy. The section of the route, which is predicted as having a high possibility of the manual driving operation being necessary due to the interruption of the automatic driving control, is determined as a manual driving section. Specifically the automatic driving control determines a manual driving section in which it is necessary for the driver to operate manual driving.

The ECU 20 sets a section of a route as a manual driving section when a number of sampling points having a unit section with the estimated accuracy lower than the threshold Th1 exceeds a predetermined number, for example. The unit section is set as a section that includes a plurality of sampling points. For example, if the number of sampling points having the unit section with lower estimated accuracy than the threshold Th1 is more than 40%, then the unit section is determined as a manual driving section. The step S18 is a manual driving section determination unit.

At step 20, the display (control selection display) enables the driver to select a route among the plurality of routes shown on the display unit 50, after the operating ratio calculated at step S17 is presented to the driver. When the automatic driving control is selected, the manual driving section is corresponded to each route and displayed on the control selection screen, in addition to the operating ratio. The manual driving section is determined at step S19. The step S20 is the route selection process.

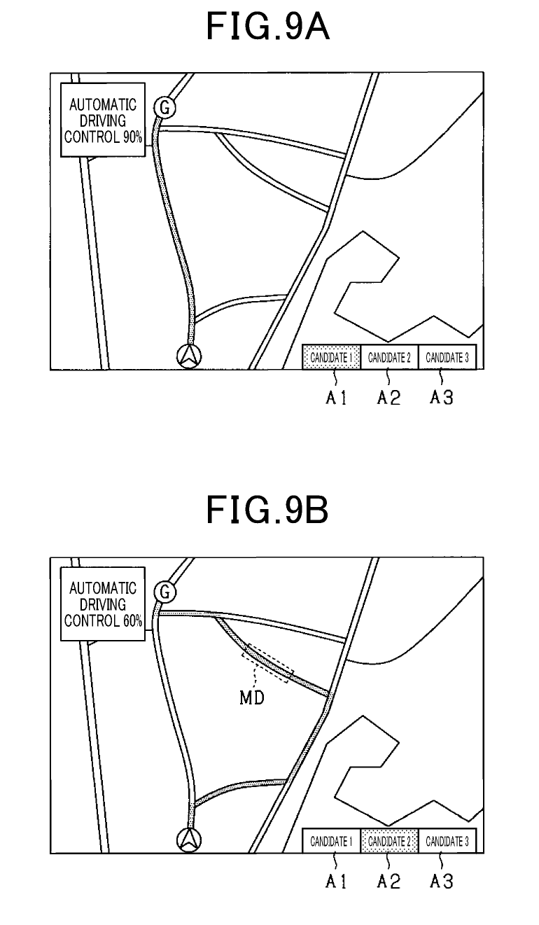

Now with reference to FIG. 9A and FIG. 9B, the control selection screen will be described. The control selection screens shown in FIG. 9A and FIG. 9.B each show the respective route candidates 1 and 2, among the three route candidates calculated in step S11 shown in FIG. 7. FIG. 9A shows the candidate route 1 which joins the present position to the destination on the selection screen, when the icon A1 is operated by the driver. In this case, a 90% operating ratio of the automatic driving control is displayed on an upper left part of the screen. In this example, the driver is thus able to visually determine that interruption of the automatic driving control (driving assistance control) occurs only occasionally on the first candidate route.

The FIG. 9B shows the candidate route 2 on the selection screen when the icon A2 is operated by the driver. In this case, a 60% operating ratio of the automatic driving control is shown on the upper left of the diagram and a manual driving section MD determined at step S18 is also additionally shown. The example shown in FIG. 9B, enables the driver to visually determine a possible interruption of driving assistance occurring on the second route candidate, and also a manual driving section MD existing where the operation of manual driving is necessary.

When the driver selects either one of the routes displayed on the control selection screen (YES at step S21), at step S22, the selected route is set as the driving route of the vehicle. For example, if the driver selects operation of the automatic driving control, the ECU 20 operates automatic driving control according to the pre-set route.

As described hereinabove, in the first embodiment, the ECU 20 extracts either the shape or the distribution of the landmarks on the plurality of routes, to the destination on the map. The estimated accuracy of the vehicle position at the sampling points provided at the predetermined intervals is calculated for each route on the basis of the extracted shape and distribution of the landmarks. The operating ratio of the driving assistance control for each of the routes is then calculated on the basis of the estimated accuracy of the sampling points, and the driver is enabled to select one of the plurality of routes after the calculated operating ratio thereof of is displayed to the driver. The driver can select the route which has the driving assistance with a low frequency of interruptions along the route, by referring to the operating ratio of each route. Furthermore, the interruption of the driving assistance control at unexpected timings whilst driving along the route is avoided, and as a result, the load to the driver also decreased.

### Effect of the First Embodiment

The ECU 20 extracts the distribution of the landmarks provided along the road, and calculated the appearing frequency of the landmarks in the direction along the road in the vicinity of the sampling points, on the basis of the extracted landmark distribution. The estimated accuracy is then calculated on the basis of the calculated appearing frequency of the landmarks. If the appearing frequency of the landmarks dispersed in the direction along the road is high, the number of times of specifying the position of the vehicle, may be thus increased by using the landmarks. In this configuration, as the appearing frequency of the landmarks is calculated on the basis of the extracted landmark distribution, the calculated value of the estimated accuracy of the position of the own vehicle increases with higher appearing frequency of the landmarks in the sampling points. Since the operating ratio of each route is calculated on the basis of the estimated accuracy which relates to the accuracy of the vehicle position in the direction along the road, the driver is able to select the route having a high accuracy of the vehicle position.

The ECU 20 is provided to continuously extract landmarks of shape change sections which indicate a division line having a shape change section on the road, and calculate the estimated accuracy on the basis of the detected results of the shape change sections in the vicinity of the sampling points. The landmarks of shape change section continuously existing on the road are largely different in shape compared to other parts of the road. A characteristic of the shape change section may thus be used to specify the vehicle position in both the length direction and also the width direction of the road. The shape change section indicating the division line having a changed shape on the road is extracted as a landmark shape, and the estimated accuracy of the vehicle position is calculated based on the results of the detected shape change section in the vicinity of the sampling points. In this case, as the estimated accuracy is calculated using the shape change section which also specifies the vehicle position with high accuracy, appropriate calculation of the estimated accuracy can thus be ensured.

When a low accuracy flag is registered for the landmark positioned in the vicinity of the sampling points, the ECU 20 calculates the accuracy of the sampling points based on the low accuracy flag, in addition to the shape and distribution of the extracted landmarks. That is, if the landmark registered on the map used to specify the position has a low measurement accuracy, the estimated precision of the vehicle position will also be low as a consequence. In this regard, when a low accuracy flag is registered on a landmark in the vicinity of the sampling points, the estimated accuracy of the sampling points is calculated on the basis of the low accuracy flags, in addition to the shape and the distribution of the extracted landmarks. In this manner, when the measuring accuracy is low for each landmark on the map, the estimated accuracy may be calculated taking the low measuring accuracy into consideration.

The ECU 20 determines whether each unit section is a manual driving section in which there is a high possibility of manual driving of the vehicle being necessary. The ECU 20 determines the manual driving sections on the basis of the number of sampling points which have a low estimated accuracy in the unit sections on the route, when the automatic driving control is selected. The driver is thus enabled to select any one of the routes, once the manual driving section of each route is presented thereto, in addition to the operating ratio. It is necessary for the driver to perform manual driving when the automatic driving control is interrupted. In this regard, according to the configuration, the ECU 20 determines sections which have many low estimated accuracy sampling points on a road as manual driving sections, where there is a high possibility of manual driving being necessary. The manual driving sections on each of the routes are then presented to the driver, in addition to the operating ratio. In this way, as the sections in which manual driving is highly possible can be presented to the driver, the options provided to the driver may also be effectively supported.

### Second Embodiment

In the second embodiment, the estimated accuracy of the vehicle position is calculated by using an error of the vehicle position in each section obtained when the vehicle is driving on the route. The error refers to a difference between the position of the vehicle on the map and a specified position of the vehicle described hereinafter.

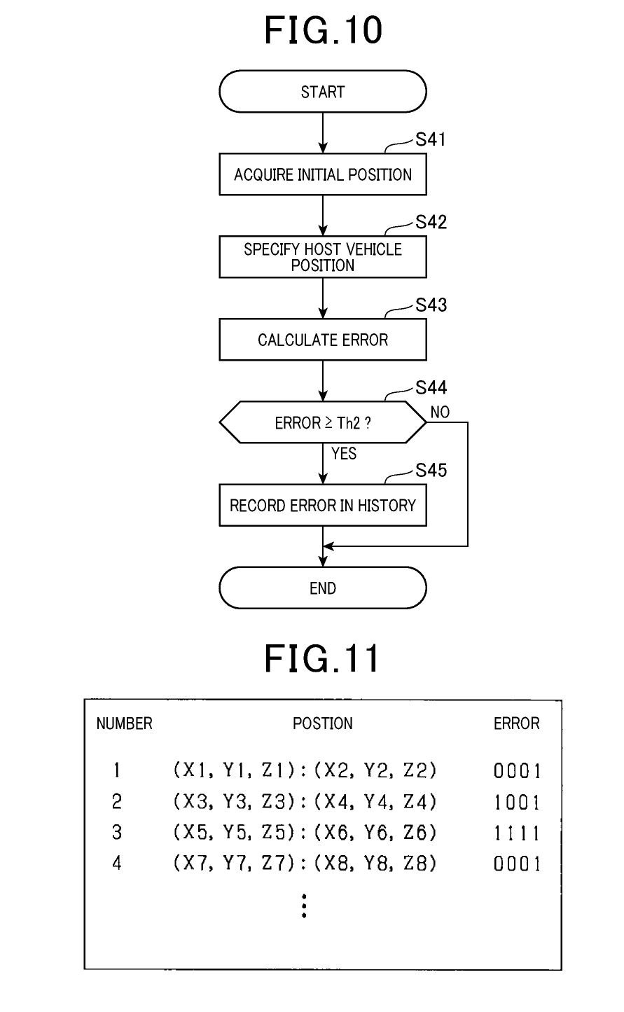

A flowchart shown in FIG. 10, describes a method to calculate the error of each section on the route, according to the second embodiment. The flowchart in FIG. 10 is a process which is executed when the vehicle is driving on the road, and more specifically executed each time the vehicle drives on a unit section.

Firstly, at step S41, a position on the map is acquired based on GPS information, for example. At step 42, the position of the vehicle is specified by correction on the basis of position alignment of the vehicle position on the map acquired at step S41, the landmark position on the map and the detected landmark position.

At step S43, the error between the position on the map acquired at step S41 and the position of the vehicle specified at step S42 is calculated. In the second embodiment the ECU 20 calculates a difference between the position on the map and the specified position of the vehicle as the error.

At step S44 the error value calculated at step S43 is compared to a threshold Th2. When the vehicle position is specified by correction of the position on the map, sections which have a large error between the two positions are predicated as sections where an error of the vehicle position occurs easily. If the position on the map is set on the basis of GPS information, and the threshold Th2 is set on the basis of the error of the GPS information, the threshold Th2 may be set to a value of 2 meters or more to 10 meters or less, for example.

At step 43, if the calculated error is less than the threshold Th2 (NO at step S44) the process is completed. In contrast, if the calculated error is higher than or equal to the threshold Th2 (YES at step 44), at step S45 the error calculated at step S43 is corresponded with the position on the map and recorded. The process steps S43 to S45 are performed by the error calculating unit.

FIG. 11 is an example of error recorded at step S45. In FIG. 11, when the error is higher than or equal to the threshold Th2, a position (specifically, co-ordinates) on the map is corresponded to the error value, and recorded. When the process in completed at step S45, the process shown in FIG. 10 is completed for the time being.

The recorded error information is used for the route selection shown in FIG. 6. That is, at step S16 in FIG. 6, the ECU 20 calculates the estimated accuracy of the sampling points existing in sections having an error recorded in history, on the basis of errors recorded in the process shown in FIG. 10, in addition to the shape and distribution of the landmarks. The ECU 20 calculates the estimated accuracy as a low value when the sections in the vicinity of the sampling points have an error value higher than threshold or equal to Th2, compared to sections with an error value that is less than the threshold Th2.

At step S17, the operating ratio of each roads is calculated according to the calculated estimated accuracy.

Effect of the Second Embodiment

As described herein above, in the second embodiment, the ECU 20 records an error between a positions on the map for each predetermined section and the position of the vehicle specified by correction of the position, when the vehicle is driving on one of the routes, among the plurality of routes. The estimated accuracy is calculated on the basis of the error recorded by an error recording unit, in addition to the shape and distribution of the landmarks located in the sampling points. When the vehicle location is specified by correction of the position on the map, the sections which have high error values between both positions are predicted as sections in which an error occurs easily. In this regard, according to the configuration described, the error between the position on the map of each predetermined section and the specified position of the vehicle is recorded, when the vehicle is actually driving along the route. The estimated accuracy may be thus calculated on the basis of the error, in addition to the shape and distribution of the landmarks for the sampling points existing in sections which have an error equal to or higher than the threshold, recorded by the error recording unit. In this case, the estimated accuracy may be calculated in consideration of an easily occurring error for each of the sections.

### Third Embodiment

In the third embodiment, a recommended manual driving section which is recommends manual driving to the driver is presented. The recommended driving sections are determined by using a section line recognition ratio obtained when the vehicle is travelling along a route. The recommended driving section has a low possibility of interruption of the driving assistance control, compared to the manual driving sections, however since the recommended driving section has a low accuracy of the vehicle position in such sections, the driving assistance control is not appropriately operable, thus manual driving is recommended.

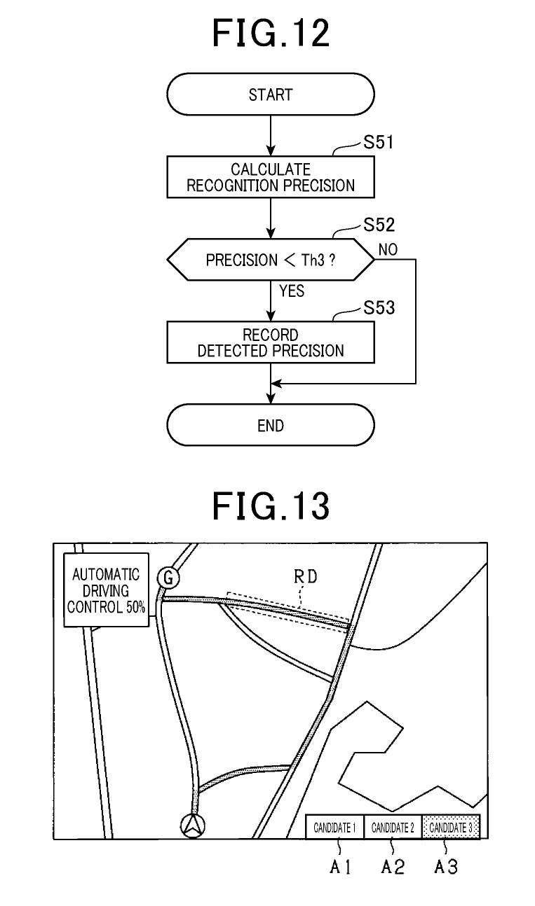

FIG. 12 is a flowchart describing a calculating method of recognition accuracy of a division line for each section on a road according to the third embodiment. The flowchart shown in FIG. 12 is a process of the vehicle shown as CS, which is operated whilst travelling along a road, for example. The vehicle executes the process when travelling each predetermined distance.

At step S51, the recognition accuracy of the division line for each unit section is calculated. For example, the ECU 20 calculates the recognition accuracy according to a degree of coincidence of the division line of measuring points detected by the measuring sensor 32, and a template used to detect the division lines. When the degree of coincidence is high, the recognition accuracy is set as a high value, and when the degree of coincidence is low the recognition accuracy is set as a low value.

At step S52, it is determined whether the recognition accuracy calculated at step S51 is lower than a threshold Th3. The threshold Th3 is experimentally set by determining whether the division line is appropriately recognized. If the recognition accuracy is higher than the threshold Th3 (NO at step S52) the process in FIG. 12 is completed for the time being.

If the recognition accuracy is lower than the threshold Th3 (YES at step S52), the recognition accuracy calculated at step S51 is recorded in the history. As a result, positions (i.e. co-ordinates) of the unit sections which have a recognition accuracy lower than the threshold Th3 and the recognition accuracy are correlated and recorded in the history. Step S53 is a process performed by the recognition accuracy recording unit.

In this manner, the error information is thus recorded and used for the route selection process described in FIG. 6. Specifically, the ECU 20 determines whether each of the unit sections are recommendable sections for manual driving, on the basis of the number of low recognition sampling points in the unit sections on each route. The recommended manual driving sections are thus recommended to the driver. Furthermore at step S19, the recommended driving sections on each of the routes are presented to the driver, in addition to the operating ratio, and the driver is enabled to select from each of the routes. In this regard, step S16 is a process performed by a recommended section determination unit, according to the third embodiment. It is to be understood that in step S16, the ECU 20 may be configured to simultaneously determine both the manual driving sections and the recommended sections.

The selection screen shown in FIG. 13 shows a candidate route among the plurality of routes to the destination, with a 50% operating ratio for the automatic driving control, shown on an upper left part of the screen. The recommended driving section RD which recommends manual driving to the driver is shown on the map in addition to the operating ratio. As a result, if the driver selects the route shown in FIG. 13, the driver is able to visually determine that it is more preferable to operate manual driving in the recommended driving section RD on the road.

Effects of the Third Embodiment

As described above, in the third embodiment, the ECU 20 records the recognition accuracy of each division line for each unit section when the vehicle is actually travelling along the route. The ECU 20 determines a recommended section recommending manual driving to the driver, on the basis of the number of sampling points which have a low recognition accuracy in the unit sections on the route. The recommended driving sections on each route are presented, in addition to the operating ratio, and the driver is enabled to select from the routes. When the division line is recognized and the vehicle position in the lanes controlled based on the recognition results, the accuracy of the vehicle position in the lane changes according to the recognition accuracy of the division lines. In the above configuration, the recognition accuracy of the division lines recognized for each unit section by the recognition unit is recorded when the vehicle is actually driving along the road. The recommended section which recommends manual driving to the driver is determined on the basis of the number of samples on the road which have a low recognition accuracy. The recommended manual driving section on each route is presented, in addition to the operating ratio, and the driver is enabled to select from each of the routes. In this case, as sections where a position on the lane is not appropriately controlled is presented to the driver, options provided to the driver may also be effectively supported.

### Other Embodiments

The driving assistance control may be an automatic driving control, an LKAS control, a lane change control or assistance at specific positions, for example, on a slope, to control a vehicle, in order to assist the driver. In this case, the ECU 20 extracts sampling points located in positions in which driving assistance control is being operated, and calculates an estimated accuracy of the extracted sampling points.

The ECU 20 may be operable to set a different route than the route selected by the driver when the driver selects the route by operating the selection screen, to perform the driving assistance control.

It is also to be understood that in the second and the third embodiments, the ECU 20 may be configured to record errors and the recognition ratio on an actual route on a map, rather than in the history. In the case of recording the data on the map, the errors and the recognition ratio are recorded in correspondence to the positions of the landmarks on the map. If the vehicle control apparatus 100 is configured to communicate with servers which are not shown, the errors and the recognition ratio of the division lines on the route in which the vehicle actually travels may be transmitted to the servers. In this case the server itself is provided with the recognition ratio of the transmitted errors and division lines. The server will then register the errors and the division lines with the positions on the map.

As a result, the larger the number of vehicles communicating with the server, the greater the amount of information of the errors and the division lines recorded on the map of the server will be. It is also to be understood that the ECU 20 may enhance the operating ratio and the accuracy information of the manual driving sections provided to the driver by performing the process shown in FIG. 6, using a map transmitted from the server.

### DESCRIPTION OF SYMBOLS

20 . . . ECU,

21 . . . recognition unit

22 . . . vehicle position specification unit

23 . . . controller

24 . . . extraction unit

25 . . . accuracy calculation unit

26 . . . operating ratio calculating unit

27 . . . route selection unit.

What is claimed is:

1. A driving assistance apparatus which operates a driving assistance control for a vehicle, on the basis of specifying a position of the vehicle which is specified by a position of a landmark on a map being a sign for the vehicle provided on a road in which the vehicle is travelling;
the apparatus comprising;
an extraction unit which extracts either one of a shape and distribution of the landmarks on a plurality of routes to a destination on the map, the routes being roads on which the vehicle travel to the to destination;
an accuracy calculation unit which calculates an estimated accuracy of the vehicle position;
an operating ratio calculation unit which calculates an operating ratio of the driving assistance control for each route; and
a route selection unit enabling the driver to select a route among a plurality of routes after the calculated operating ratio is presented to the driver; wherein,
the accuracy of the vehicle position is estimated at sampling points positioned at predetermined intervals on each of the routes, on the basis of the shape and distribution of the landmarks, and
the operating ratio of the driving control is calculated on the basis of the calculated estimated accuracy at the sampling points.

2. The driving assistance apparats according to claim 1, wherein,
the extraction unit extracts the distribution of the landmarks dispersed along the road,
the accuracy calculation unit calculates an appearing frequency of the landmarks in a direction of the road in an area in which the sampling points are positioned, on the basis of the distribution of the extracted landmarks, and calculates the estimated accuracy on the basis of the calculated appearing frequency of the landmarks.

3. The driving assistance apparatus according to claim 1, wherein,
the extraction unit extracts a shape change section of a landmark indicating a changed shape of a road, which is continuously provided along the road, and
the accuracy calculation unit calculates the estimated accuracy on the basis of whether the change shape section exists in the vicinity of the sampling points.

4. The driving assistance apparatus according to claim 1, wherein,
the map is provided with a registered low accuracy information which indicates that a measuring accuracy of the landmarks is less than a predetermined value, and
the accuracy calculation unit calculates the estimated accuracy of the sampling points on the basis of the low accuracy information, in addition to the shape and the distribution of the landmarks.

5. The driving assistance apparatus according to claims 1, the apparatus further comprises:
a position measuring sensor; and
an error recording unit, wherein,
the vehicle position is specified by correction on the basis of a result of position alignment of the vehicle position on the map, the land mark position on the map, and the recognized land mark position which is recognized by the recognition unit, the vehicle position on the map being acquired on the basis of a measured position result of the position measuring sensor,
the error recording unit corresponds an error between the position on the map at each predetermined section whilst the vehicle is travelling along the road, and the vehicle position specified by correction of the position on the map, with the position on the map and records the error, and
the accuracy calculation unit calculates the estimated accuracy on the basis of the error recorded by the error recording unit, in addition to either one of the shape and the distribution of the landmarks.

6. The driving assistance apparatus according to claim 1, wherein,
the driving assistance control is an automatic driving control running the vehicle, provided with
a driving section determination unit which determines a manual driving section in which a possibility of manual driving being necessary is high for the vehicle, determined on the basis of a number of the sampling points which have a low estimated accuracy in a unit section on the route, the unit section being a section that includes a plurality of sampling points, and
the route selection unit presents the manual driving section on each of the routes, in addition to the operating ratio, and enables the driver to select a route.

7. The driving assistance apparatus according to claim 1, wherein,
the driving assistance control recognizes division lines dividing a lane recognized at the recognition unit, and controls the vehicle position on the lane on the basis of a detected division line, the driving assistance control is provided with
a recognition accuracy recording unit which records a recognized accuracy of the division lines recognized by the recognition unit for each unit section, when the vehicle is actually travelling along the route, and
a recommended section determination unit which determines a recommended section recommending the manual driving to the driver, on the basis of, the number of sampling points having the low recognition accuracy in the unit sections on the route, wherein,
the route selection unit presents the recommended section on each of the routes, in addition to the operating ratio, and enables the driver to select a route.

8. A driving assistance method for control of driving assistance of a vehicle, on the basis of specifying a position of the vehicle which is specified by a position of a landmark on a map being a sign for the vehicle provided on a road in which the vehicle is travelling;
the method comprising;
an extraction process for extracting either one of a shape and distribution of the landmarks on a plurality of routes to a destination on the map;
an accuracy calculation process for calculating an estimated accuracy of the vehicle position;
an operating ratio calculation process for calculating an operating ratio of the driving assistance control for each route; and
a route selection process for enabling the driver to select a route among a plurality of routes after the calculated ratio is presented to the driver; wherein
the accuracy calculation process calculates the estimated accuracy of the vehicle at sampling points positioned at predetermined intervals on each of the routes, on the basis of the shape and distribution of the landmarks, and
the operating ratio of the driving assistance control is calculated on the basis of the calculated estimated accuracy at the sampling points.

9. The driving assistance apparatus according to claim 2, wherein,
the extraction unit extracts a shape change section of a landmark indicating a changed shape of a road, which is continuously provided along the road, and
the accuracy calculation unit calculates the estimated accuracy on the basis of whether the change shape section exists in the vicinity of the sampling points.

10. The driving assistance apparatus according to claim 2, wherein,
the map is provided with a registered low accuracy information which indicates that a measuring accuracy of the landmarks is less than a predetermined value, and
the accuracy calculation unit calculates the estimated accuracy of the sampling points on the basis of the low accuracy information, in addition to the shape and the distribution of the landmarks.

11. The driving assistance apparatus according to claim 3, wherein,
the map is provided with a registered low accuracy information which indicates that a measuring accuracy of the landmarks is less than a predetermined value, and
the accuracy calculation unit calculates the estimated accuracy of the sampling points on the basis of the low accuracy information, in addition to the shape and the distribution of the landmarks.

12. The driving assistance apparatus according to claim 2, the apparatus further comprises:
a position measuring sensor; and
an error recording unit, wherein,
the vehicle position is specified by correction on the basis of a result of position alignment of the vehicle position on the map, the land mark position on the map, and the recognized land mark position which is recognized by the recognition unit, the vehicle position on the map being acquired on the basis of a measured position result of the position measuring sensor,
the error recording unit corresponds an error between the position on the map at each predetermined section whilst the vehicle is travelling along the road, and the vehicle position specified by correction of the position on the map, with the position on the map and records the error, and
the accuracy calculation unit calculates the estimated accuracy on the basis of the error recorded by the error recording unit, in addition to either one of the shape and the distribution of the landmarks.

13. The driving assistance apparatus according to claim 3, the apparatus further comprises:
a position measuring sensor; and
an error recording unit, wherein,
the vehicle position is specified by correction on the basis of a result of position alignment of the vehicle position on the map, the land mark position on the map, and the recognized land mark position which is recognized by the recognition unit, the vehicle position on the map being acquired on the basis of a measured position result of the position measuring sensor,
the error recording unit corresponds an error between the position on the map at each predetermined section whilst the vehicle is travelling along the road, and the vehicle position specified by correction of the position on the map, with the position on the map and records the error, and
the accuracy calculation unit calculates the estimated accuracy on the basis of the error recorded by the error recording unit, in addition to either one of the shape and the distribution of the landmarks.

14. The driving assistance apparatus according to claim 2, wherein,
the driving assistance control is an automatic driving control running the vehicle, provided with
a driving section determination unit which determines a manual driving section in which a possibility of manual driving being necessary is high for the vehicle, determined on the basis of a number of the sampling points which have a low estimated accuracy in a unit section on the route, the unit section being a section that includes a plurality of sampling points, and
the route selection unit presents the manual driving section on each of the routes, in addition to the operating ratio, and enables the driver to select a route.

15. The driving assistance apparatus according to claim 3, wherein,
the driving assistance control is an automatic driving control running the vehicle, provided with
a driving section determination unit which determines a manual driving section in which a possibility of manual driving being necessary is high for the vehicle, determined on the basis of a number of the sampling points which have a low estimated accuracy in a unit section on the route, the unit section being a section that includes a plurality of sampling points, and
the route selection unit presents the manual driving section on each of the routes, in addition to the operating ratio, and enables the driver to select a route.

16. The driving assistance apparatus according to claim 4, wherein,
the driving assistance control is an automatic driving control running the vehicle, provided with
a driving section determination unit which determines a manual driving section in which a possibility of manual driving being necessary is high for the vehicle, determined on the basis of a number of the sampling points which have a low estimated accuracy in a unit section on the route, the unit section being a section that includes a plurality of sampling points, and
the route selection unit presents the manual driving section on each of the routes, in addition to the operating ratio, and enables the driver to select a route.

17. The driving assistance apparatus according to claim 2, wherein,
the driving assistance control recognizes division lines dividing a lane recognized at the recognition unit, and controls the vehicle position on the lane on the basis of a detected division line, the driving assistance control is provided with
a recognition accuracy recording unit which records a recognized accuracy of the division lines recognized by the recognition unit for each unit section, when the vehicle is actually travelling along the route, and
a recommended section determination unit which determines a recommended section recommending the manual driving to the driver, on the basis of, the number of sampling points having the low recognition accuracy in the unit sections on the route, wherein,
the route selection unit presents the recommended section on each of the routes, in addition to the operating ratio, and enables the driver to select a route.

18. The driving assistance apparatus according to claim 3, wherein,
the driving assistance control recognizes division lines dividing a lane recognized at the recognition unit, and controls the vehicle position on the lane on the basis of a detected division line, the driving assistance control is provided with
a recognition accuracy recording unit which records a recognized accuracy of the division lines recognized by the recognition unit for each unit section, when the vehicle is actually travelling along the route, and
a recommended section determination unit which determines a recommended section recommending the manual driving to the driver, on the basis of, the number of sampling points having the low recognition accuracy in the unit sections on the route, wherein,
the route selection unit presents the recommended section on each of the routes, in addition to the operating ratio, and enables the driver to select a route.

19. The driving assistance apparatus according to claim 4, wherein,
the driving assistance control recognizes division lines dividing a lane recognized at the recognition unit, and controls the vehicle position on the lane on the basis of a detected division line, the driving assistance control is provided with
a recognition accuracy recording unit which records a recognized accuracy of the division lines recognized by the recognition unit for each unit section, when the vehicle is actually travelling along the route, and
a recommended section determination unit which determines a recommended section recommending the manual driving to the driver, on the basis of, the number of sampling points having the low recognition accuracy in the unit sections on the route, wherein,
the route selection unit presents the recommended section on each of the routes, in addition to the operating ratio, and enables the driver to select a route.

20. The driving assistance apparatus according to claim 5, wherein,
the driving assistance control recognizes division lines dividing a lane recognized at the recognition unit, and controls the vehicle position on the lane on the basis of a detected division line, the driving assistance control is provided with
a recognition accuracy recording unit which records a recognized accuracy of the division lines recognized by the recognition unit for each unit section, when the vehicle is actually travelling along the route, and
a recommended section determination unit which determines a recommended section recommending the manual driving to the driver, on the basis of, the number of sampling points having the low recognition accuracy in the unit sections on the route, wherein,
the route selection unit presents the recommended section on each of the routes, in addition to the operating ratio, and enables the driver to select a route.
